(19) United States
(12) Patent Application Publication
(10) Pub. No.: US 2008/0056719 A1
(43) Pub. Date: Mar. 6, 2008

(54) Method and apparatus for enabling an optical network terminal in a passive optical network

(76) Inventors: Marc R. Bernard, Miramar, FL (US); Mark D. Mueller, Naperville, IL (US); John A. Stock, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/514,686

(22) Filed: Sep. 1, 2006

(51) Int. Cl. H04J 14/00

(52) U.S. Cl. 398/71

(57) ABSTRACT

A method and corresponding apparatus for automatically enabling and disabling an Optical Network Terminal (ONT) to communicate upstream with a network device, such as an Optical Line Terminal (OLT), is provided. The ONT includes at least one timing mechanism to time a duration of the ONT's being in an enabled or disabled state of upstream communications. After a timing mechanism times a desired duration, the ONT automatically changes between states of upstream communications (e.g., from enabled state to disabled state). The ONT may alternate between the enabled and disabled states of upstream communications until communications are established with the OLT. This method and corresponding apparatus prevent prolonged installation time because a technician can install the ONT without consideration of the ONT's state of upstream communications.

### BACKGROUND OF THE INVENTION

In a communications network, a direction of communications is typically described as being either upstream or downstream relative to a fixed point in the communications network. For example, communications directed from a subscriber terminal toward a central office is described as upstream communications, while communications directed from the central office toward the subscriber terminal is described as downstream communications. Oftentimes, the subscriber terminal, such as an Optical Network Terminal (ONT), may connect to a Passive Optical Network (PON) element at the central office in a disabled state of upstream communications without the knowledge of the PON element. As a result, the PON element does not range with the ONT.

### SUMMARY OF THE INVENTION

A method and corresponding apparatus for enabling an Optical Network Terminal (ONT) in a Passive Optical Network (PON) is provided. The method according to an example embodiment of the invention includes: (i) monitoring a communications connection between the ONT and the PON element for a downstream signal; (ii) timing a duration of the ONT's being in a disabled state of upstream communications after detecting the downstream signal; and (iii) causing the ONT to enter an enabled state of upstream communications in an event the timing of the duration reaches a terminal count or causing the ONT to enter a state of upstream communications based on content of a received valid signal.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a network diagram of an exemplary Optical Communications Network illustrating an Optical Network Terminal (ONT) employing an embodiment of the present invention;

FIG. 1B is a network diagram of an exemplary Passive Optical Network (PON) employing embodiments of the present invention;

FIGS. 2A-2C are diagrams illustrating an exemplary situation in which an ONT is installed in the PON in a disabled state of upstream communications;

FIG. 3 is an example flow diagram performed in accordance with an embodiment of the present invention;

FIGS. 4A-4D are block diagrams of example PON elements and ONTs operating in accordance with embodiments of the present invention;

FIGS. 5 and 6 are exemplary flow diagrams performed in accordance with other example embodiments of the present invention; and

FIGS. 7A-7G are block diagrams of example PONs illustrating operation of an ONT in accordance with embodiments of the present invention.

### DETAILED DESCRIPTION OF THE INVENTION

A description of example embodiments of the invention follows.

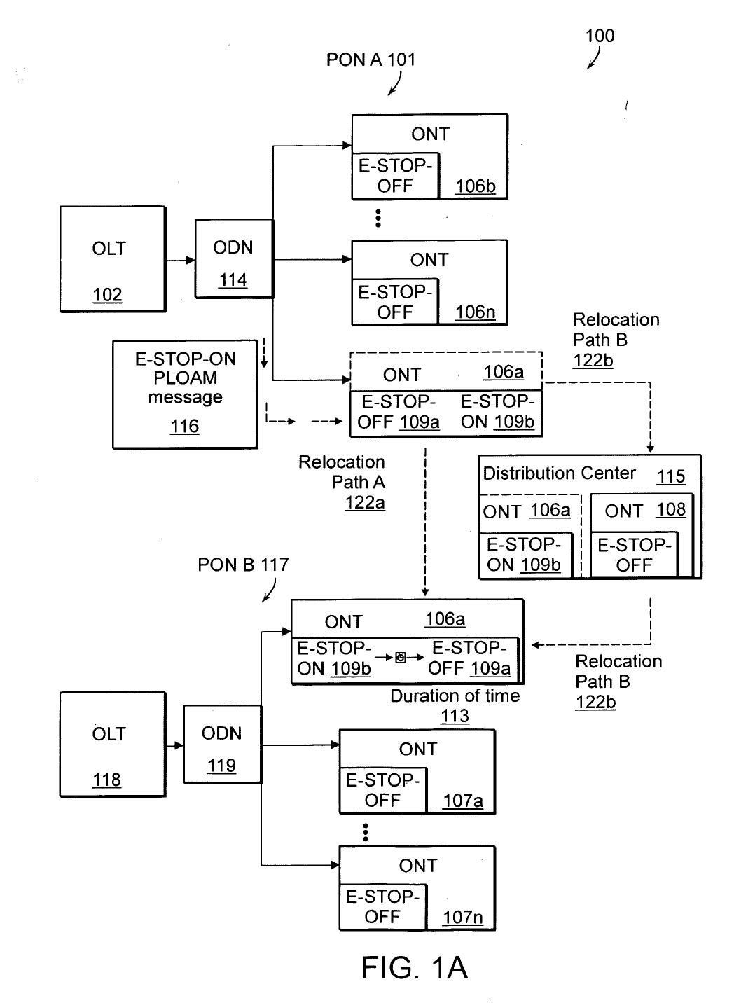

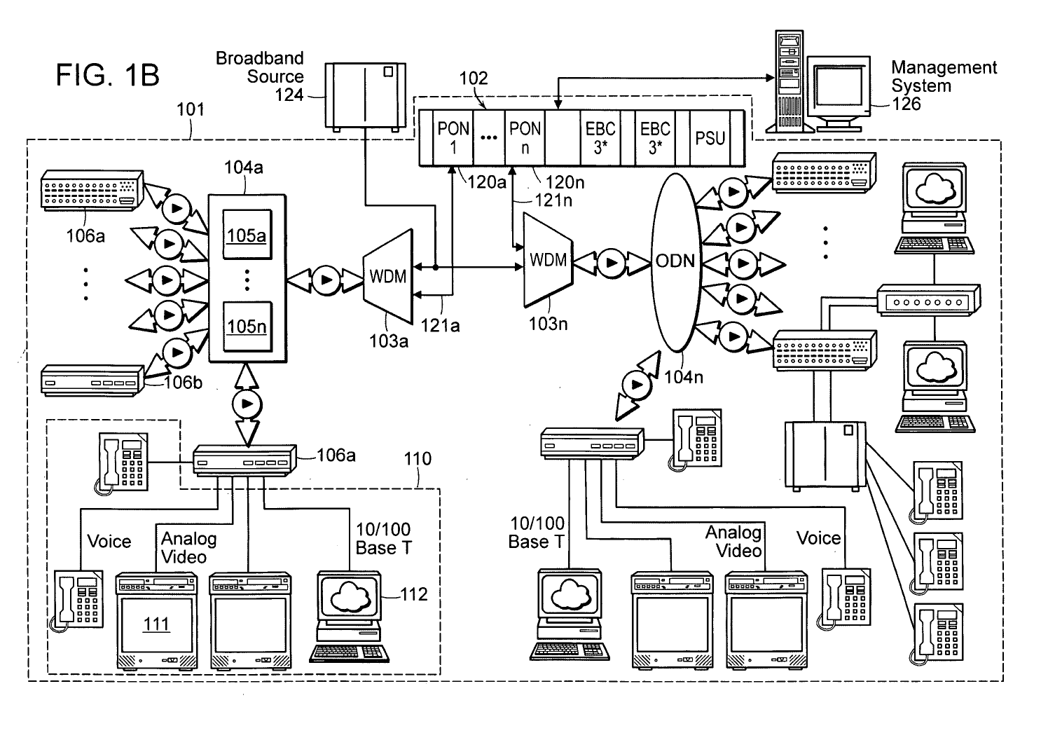

FIG. 1A is a network diagram of an exemplary Optical Communications Network illustrating an Optical Network Terminal (ONT) employing an embodiment of the present invention. The Optical Communications Network 100 includes at least two Passive Optical Networks (PON), PON A 101 and PON B 117. PON A 101 includes an Optical Distribution Network (ODN) 114, which has an Optical Line Terminal (OLT) 102 connected to ONTs 106a, 106b, . . . , 106n. In normal operation, one of the ONTs, such as ONT 106a, may be configured, provisioned, or signaled in an E-STOP-OFF state 109a of upstream communications. The E-STOP-OFF state is defined as a state in which an ONT is in a state of enabled upstream communications. During the E-STOP-OFF state 109a, the ONT 106a may communicate in an upstream direction with the OLT 102 via the ODN 114. The upstream communications may be provided on a 1310 nanometer wavelength signal. In response to an E-STOP-ON PLOAM message 116, the ONT 106a enters an E-STOP-ON state 109b of upstream communications. The E-STOP-ON state is defined as a state in which an ONT is in a state of disabled upstream communications.

In one scenario, the ONT 106a may be relocated to another PON, such as the PON B 117, via relocation path A 122a. After the relocation, the PON B 117 includes multiple ONTs 106a, 107a, . . . , 107n connected to an OLT 118 via an ODN 119. In another scenario, the ONT 106a may be relocated to the PON B 117 via a distribution center 115 along a relocation path B 122b. The distribution center 115 may contain the ONT 106a and other ONTs, such as an ONT 108. In yet another scenario, the ONT 106a may be relocated back to the original PON, such as PON A 101, after being relocated to the distribution center 115.

Oftentimes, the ONT 106a is relocated without consideration of which E-STOP state it is in and, as a result, causes a technician to be confused because the ONTs that are stored in the distribution center 115 or relocated directly to PON B 117 may be in the E-STOP-ON state 109b, which prevents installation for reasons that may not be immediately clear to the technician. Example embodiments of the present invention automatically set the relocated ONT 106a into an E-STOP-OFF state at least for a short duration of time 113 (e.g., 1-30 minutes) sufficient to allow installation to occur and to prevent prolonged installation time for the technician.

FIG. 1B is a network diagram of an exemplary Passive Optical Network-A (PON) 101 employing embodiments of the present invention. The PON A 101 includes an Optical Line Terminal (OLT) 102, Wavelength Division Multiplexers (WDMs) 103a, . . . , 103n, Optical Distribution Network (ODN) devices 104a, . . . , 104n, ODN device splitters (e.g., ODN device splitters 105a, . . . , 105n associated with ODN device 104a), Optical Network Terminals (ONTs) (e.g., 106a, 106b, . . . , 106n corresponding to ODN device splitters 105a, . . . , 105n), and customer premises equipment (e.g., 110). The OLT 102 includes PON cards 120a, . . . , 120n which provide corresponding optical feeds 121a, . . . , 121n to respective ODN devices 104a, . . . , 104n. Optical feed 121a, for example, is distributed through corresponding ODN device 104a by separate ODN device splitters 105a, . . . , 105n to respective ONTs 106a, 106b, . . . , 106n in order to provide communications to and from customer premises equipment 110.

The PON A 101 may be deployed for fiber-to-the-business (FTTB), fiber-to-the-curb (FTTC), and fiber-to-the-home (FTTH) applications. The optical feeds 121a, 121n in PON A 101 may operate at bandwidths such as 155 megabits per second (Mb/s), 622 Mb/s, 1.25 gigabits per second (Gb/s), and 2.5 Gb/s or any other desired bandwidth implementations. The PON A 101 may incorporate asynchronous transfer mode (ATM) communications, broadband services such as Ethernet access and video distribution, Ethernet point-to-multipoint topologies, and native communications of data and time division multiplex (TDM) formats. Customer premises equipment (e.g., 110) that can receive and provide communications in the PON A 101 may include standard telephones (PSTN and cellular), Internet Protocol telephones, Ethernet units, video devices (e.g., 111), computer terminals (e.g., 112), digital subscriber line connections, cable modems, wireless access, as well as any other conventional device.

A PON A 101 includes one or more different types of ONTs (e.g., 106a, 106b, 106n). Each ONT 106a, 106b, . . . , 106n, for example, communicates with an ODN device 104a through associated ODN device splitters 105a, . . . , 105n. Each ODN device 104a, . . . , 104n in turn communicates with an associated PON card 120a, . . . , 120n through respective WDMs 103a, . . . , 103n. Communications between the ODN devices 104a, . . . , 104n and the OLT 102 occur over a downstream wavelength and an upstream wavelength. The downstream communications from the OLT 102 to the ODN devices 104a, . . . , 104n may be provided at 622 Mb/s, which is shared across all ONTs connected to the ODN devices 104a, . . . , 104n. The upstream communications from the ODN devices 104a, . . . , 104n to the PON cards 120a, . . . , 120n may be provided at 155 Mb/s, which is shared among all ONTs connected to the ODN devices 104a, . . . , 104n.

A broadband source 124, of which a cable television feed through an Erbium Doped Fiber Amplifier (EDFA) is just one example, may provide video or other broadband data to the WDMs 103a, . . . , 103n using a single wavelength (hereinafter, video wavelength). The WDMs 103a, . . . , 103n multiplex the PON upstream and downstream communications wavelengths and the video wavelength and provide the resulting multiplexed signals to respective ODN devices 104a, . . . , 104n. Each ONT (e.g., 106a, 106b, . . . , 106n) may monitor a broadband overlay signal provided by broadband source 124. One example of a broadband overlay signal is a 1550 nanometer signal used for downstream video applications.

Many OLTs have an ability to provision ONTs with an Emergency Stop (E-STOP) state. The E-STOP state is defined by Broadband Passive Optical Network (BPON ITU-T G.983) standards or Gigabit Passive Optical Network (GPON ITU-T G.984) standards as a state of upstream communications from the ONT to the OLT having an enabled state or a disabled state. That is, upstream communications are enabled if the state of upstream communications is in an E-STOP-OFF state. Conversely, upstream communications are disabled if the state of upstream communications is in an E-STOP-ON state. The standards further define a Passive Optical Network (PON) element, such as the OLT, sending a pre-defined Physical Layer Operation, Administration, and Management (PLOAM) message to specific ONTs telling these ONTs to go into either an enabled or disabled state of upstream communications. Other technologies such as ATM PON (APON) and Ethernet PON (EPON) may support the ability to use a state similar to the E-STOP state as described herein.

The PLOAM message, or any other similar signal such as an E-STOP command, may be used in an event a rogue ONT arises in the field. Rogue ONTs are defined herein as ONTs that are misbehaving. An ONT may misbehave for many reasons. For example, an ONT may misbehave by transmitting at all times instead of during their grant window or transmitting at the same time as other ONTs and therefore interrupting the communications channels between the OLT's PON card and other ONTs. One way to troubleshoot a PON having rogue ONTs is to send Disable_serial_number PLOAM messages to the ONTs in the PON which cause the ONTs with the serial numbers in the PLOAM messages to stop transmitting upstream until told otherwise by the OLT or other supervisory network device. Refer to the International Telecommunication Union (ITU) G.983.1 for additional information on the Disable_serial_number and Emergency Stop State behavior for ONTs. For example, a PON card may transmit an E-STOP-ON PLOAM message (ITU G.983.1) to cause all ONTs connected to the PON card to go into the disabled state of upstream communications. The OLT may then individually enable the ONTs in order to isolate the rogue ONTs.

Emergency Stop conditions are essentially described by two states for which an ONT can be provisioned by a management system:
E-STOP-ON: The E-STOP-ON state is defined as a state in which an ONT is in an Emergency Stop state (i.e., a state of disabled upstream communications). A PON element may cause the ONT to go into the E-STOP-ON state by sending a Disable_serial_number PLOAM message to the ONT. According to ITU G.983.1, a network device, such as an ONT, enters an E-STOP-ON state when the ONT receives a Disable_serial_number PLOAM message with its own serial number and an enable flag=0xFF. This message is referred to hereinafter as an E-STOP-ON PLOAM message. The ONT stays in this state even after powering off. During the E-STOP-ON state, the ONT does not communicate in an upstream direction, but continues to receive and process downstream communications.
E-STOP-OFF: The E-STOP-OFF state is defined as a state in which an ONT is not in an Emergency Stop state (i.e., a state of enabled upstream communications). During the E-STOP-OFF state, the ONT can communicate upstream with the OLT. According to ITU G.983.1, a network device, such as an ONT, enters an E-STOP-OFF state when the ONT receives a Disable_serial_number PLOAM message with an enable flag=0x0F or when the ONT receives a Disable_serial_number PLOAM message with its own serial number and the enable flag=0x00. These messages are referred to hereinafter as E-STOP-OFF PLOAM messages.

Typically, a PON element, such as an OLT or other network devices, is aware of an ONT is connected to it. For example, the PON element may be aware of the ONT's presence because the ONT, when in a state of enabled upstream communications, may notify the PON element that it is connected to the PON. In another example, a service provider may provide a list of all ONTs' serial numbers within the PON to the PON element. Once the PON element is aware of the ONT's presence, a PON element can range with the ONT to enable communications between the PON element and the ONT. The PON element may be a management system, PON card, or Optical Line Terminal (OLT).

Once the PON element ranges with the ONT, the PON element may provision the ONT to enable or disable upstream communications. For example, a service provider who is troubleshooting a problematic PON may isolate a rogue ONT by provisioning or signaling different ONTs on the PON to be in an E-STOP-ON or E-STOP-OFF state (i.e., a disabled or enabled state of upstream communications, respectively). The rogue ONT or another ONT may then be removed from the PON. These ONTs maintain the provisioned or signaled E-STOP state at all times, including across reboots, unless the ONTs have been told by the PON element to change states.

In certain situations, the PON element may not be aware of an ONT connected to it. For example, when the ONT is in a disabled state of upstream communications and is installed in the PON, the PON element may not have a complete list of all ONTs' serial numbers. In these situations, the ONT can change from the disabled state of upstream communications to the enabled state of upstream communications only if the ONT receives a valid signal, such as a PLOAM message, unless manually changed. But, the PON element may never send the valid signal to the ONT because the PON element may not be aware of it.

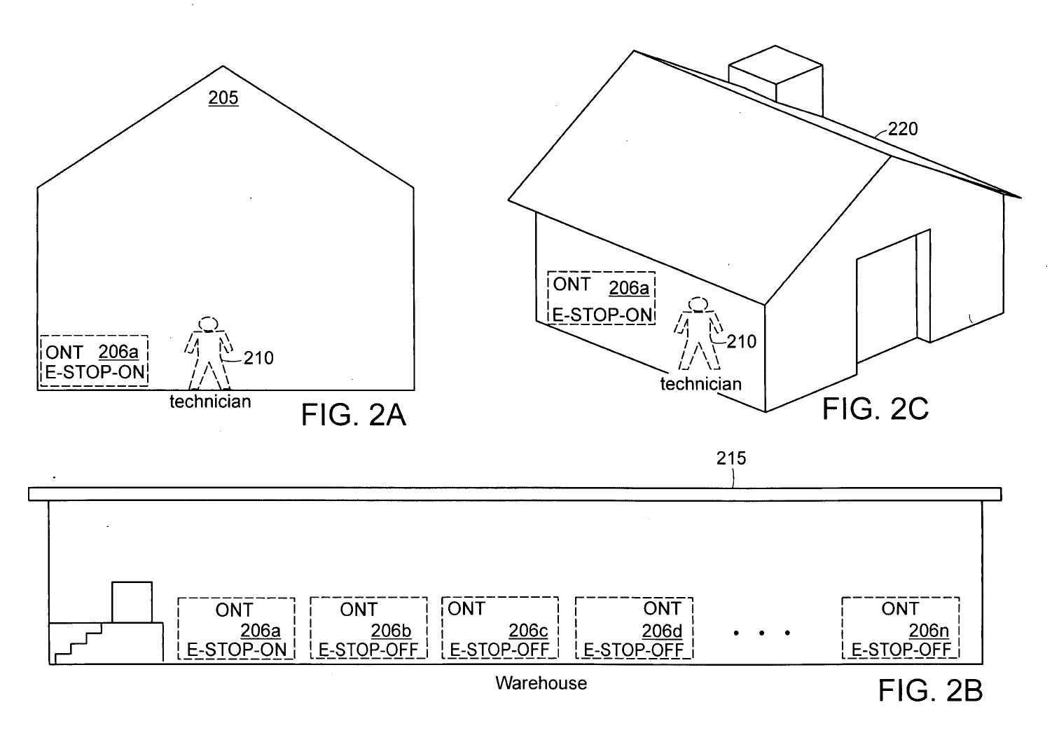

FIGS. 2A-2C are diagrams illustrating an exemplary situation in which an ONT 206a is installed in a PON in the disabled state of upstream communications. The ONT 206a may be an ONT from Tellabs® 1600 Optical Network Terminal Series produced by Tellabs Corporation of Naperville, Ill. A technician 210 may remove the ONT 206a from a subscriber's home 205 and from a PON (not shown) for a variety of reasons. A reason relevant to some embodiments of the present invention is the ONT 206a may be a rogue ONT that is adversely affecting communications between the PON element and ONTs connected to the PON element because the ONTs communicate with the PON element over a common optical wavelength and fiber optic media. For example, the ONT 206a may be sending an optical signal up to the PON element at inappropriate times, resulting in the PON element not being able to communicate with any of the other ONTs connected to the PON element. As described above, the ONT 206a may maintain an E-STOP-ON state after it is removed from the subscriber's home 205 and the PON to which the ONT 206a is connected. In this exemplary situation, the ONT 206a is in the disabled state of upstream communications. The status of the ONT's being in the disabled state or enabled state may be stored in memory of the ONT 206a.

The technician 210 may then store the ONT 206a in the disabled state of upstream communications in a warehouse 215. In the warehouse 215, there may be other ONTs 206b-206n that may be in the enabled state of upstream communications. Later, the technician, without knowing that the ONT 206a is in the disabled state of upstream communications, may re-deploy the ONT 206a in another house 220 and connect the ONT 206a to another PON element. The ONT 206a, however, may remain in the disabled state of upstream communications because the other PON element may not be aware of the ONT 206a and thus may not send a valid signal to the ONT 206a to cause the ONT 206a to change to the enabled state of upstream communications. As a result, the PON element is unable to range with the ONT 206a until the ONT 206a receives the valid signal, such as a PLOAM message.

Also, if the ONT is in a disabled state of upstream communications, a user may be able to receive free video services, for example, on a 1550 nanometer wavelength signal, because the ONT is in the enabled state of downstream communications, in some network cases regardless of the state of upstream communications.

The PON element may automatically send a request for all ONT's serial numbers in the PON because the PON element may recognize that it does not have a complete list of all ONTs in its PON. The PON element may not have a complete list of all ONTs in the PON because the ONT may have been installed in the wrong PON. The automatic request (“auto-request”) may help a technician find missing ONTs and ensure that proper ONTs are installed in a PON. However, an ONT that is in a disabled state of upstream communications cannot respond to the auto-request.

Accordingly, what is needed is a method or corresponding apparatus for enabling upstream communications (i.e., configuring an ONT to be in an E-STOP-OFF state) of an ONT in a PON, at least for a short amount of time, to allow a technician or end user to connect it to a network and allow it to be recognized by or connected to a network element (e.g., OLT) for installation or other purposes.

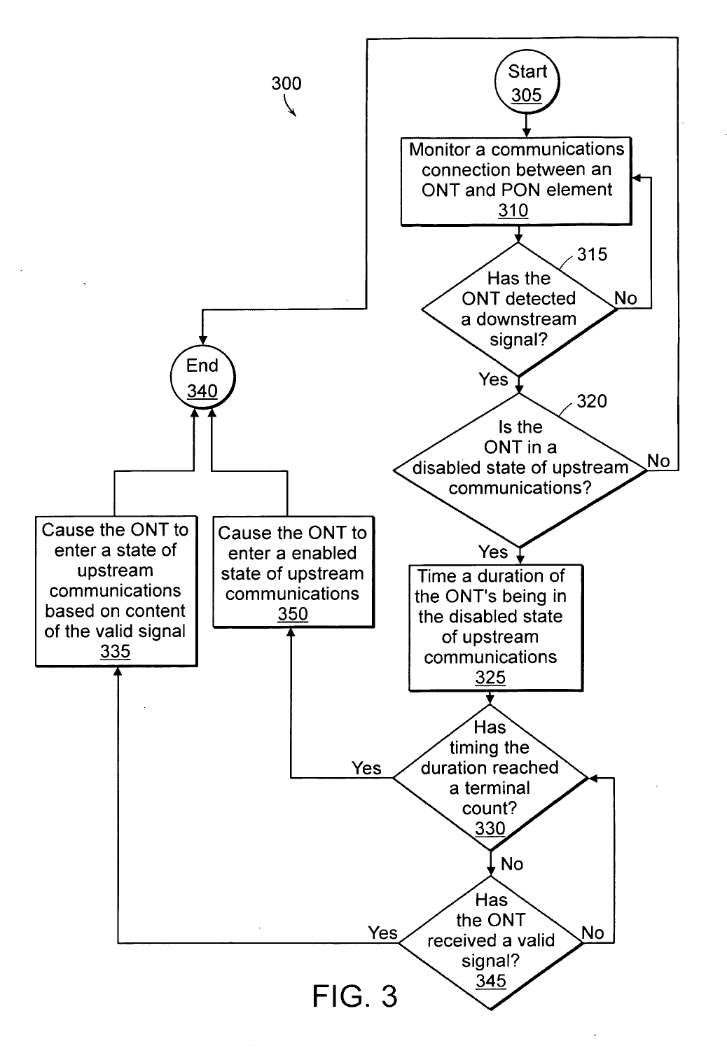

FIG. 3 is an example flow diagram 300 performed in accordance with an embodiment of the present invention. After starting (305), a communications connection between an ONT and a PON element is monitored for a downstream signal (310), such as optical signal power. The PON element may be a management system, PON card, or Optical Line Terminal (OLT).

The ONT may then determine whether it has detected a downstream signal (315). If the ONT has not detected the downstream signal, the ONT continues to monitor the communications connection (310). However, if the ONT detects a downstream signal, the ONT determines whether it is in a disabled state of upstream communications (320). The disabled state of upstream communications may be an Emergency Stop On (E-STOP-ON) state. The E-STOP-ON state tells the ONT to go into Emergency Stop state. Again, according to ITU G.983.1, a network device, such as an ONT, enters an E-STOP-ON state when it receives a Disable_serial_number message with its own serial number and an enable flag=0xFF (E-STOP-ON PLOAM message). The ONT typically remains in this state at all times, even after the ONT is powered down. During the disabled state of upstream communications, the ONT does not transmit communications signals in the upstream direction, but continues to receive and process downstream communications signals from the PON element.

If the ONT determines that it is not in the disabled state of upstream communications, it ends (340) the example flow diagram 300 and follows a normal method of ranging and activation. The ONT may start again (305) if the ONT is subsequently powered down or loses the downstream optical signal. On the other hand, if the ONT determines that it is in the disabled state of upstream communications, a duration of the ONT's being in the disabled state of upstream communications is timed (325).

Next, the ONT determines whether the timing of the duration of the ONT's being in the disabled state of upstream communications reaches a terminal count (330). If the ONT reaches a terminal count, the ONT enters an enabled state of upstream communications (350). The enabled state of upstream communications may be an Emergency Stop OFF (E-STOP-OFF) state. According to ITU G.983.1, a network device, such as an ONT, may also enter the E-STOP-OFF state when the ONT receives a Disable_serial_number PLOAM message with an enable flag=0x0F or when it receives a Disable_serial_number PLOAM message with its own serial number and the enable flag=0x00 (E-STOP-OFF PLOAM messages). After ending (340), the ONT maintains the enabled state of upstream communications.

If the ONT has not reached a terminal count, the ONT determines whether it has received a valid signal (345). The valid signal may be the E-STOP-ON PLOAM message or one of the E-STOP-OFF PLOAM messages. If the ONT determines that it did not receive a valid signal, the ONT continues to determine whether the timing duration has reached the terminal count (330). If the ONT determines that it has received a valid signal, the ONT enters a state of upstream communications based on the content of the valid signal (335). If the content of the valid signal is an E-STOP-ON PLOAM message, the ONT may enter the disabled state of upstream communications, such as the E-STOP-ON state. As discussed above, during the E-STOP-ON state, the ONT does not communicate upstream communications, but continues to receive and process downstream communications. If the content of the valid signal is an E-STOP-OFF PLOAM message, the ONT enters the enabled state of upstream communications. After the ONT enters the state of upstream communications based on the content of the valid signal, the example flow diagram 300 ends (340) and the ONT maintains the state of upstream communications.

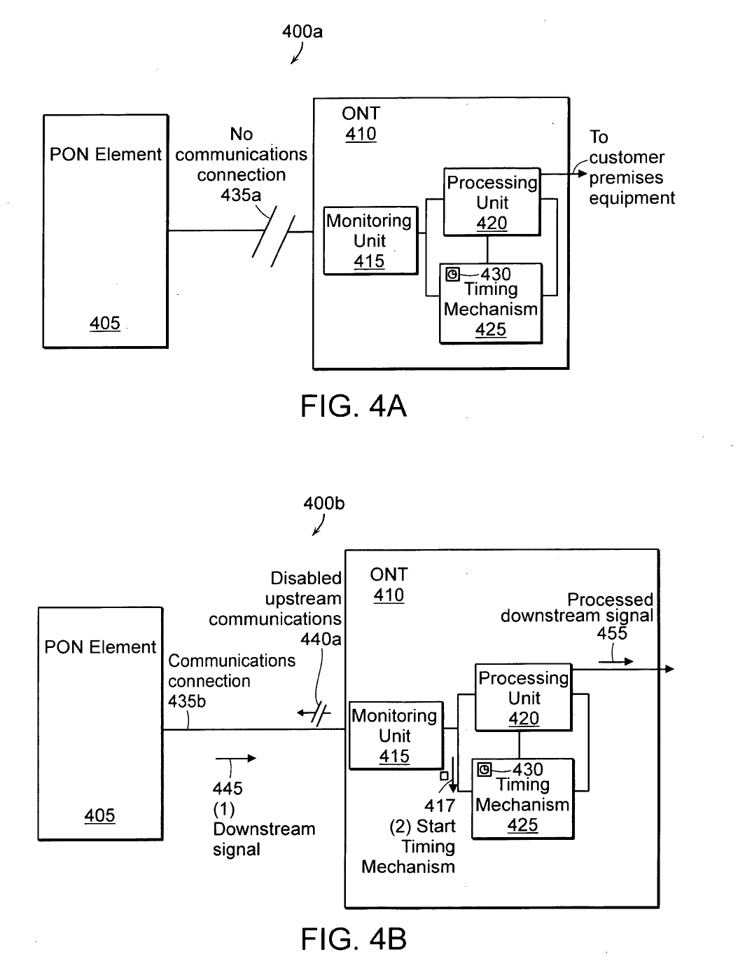

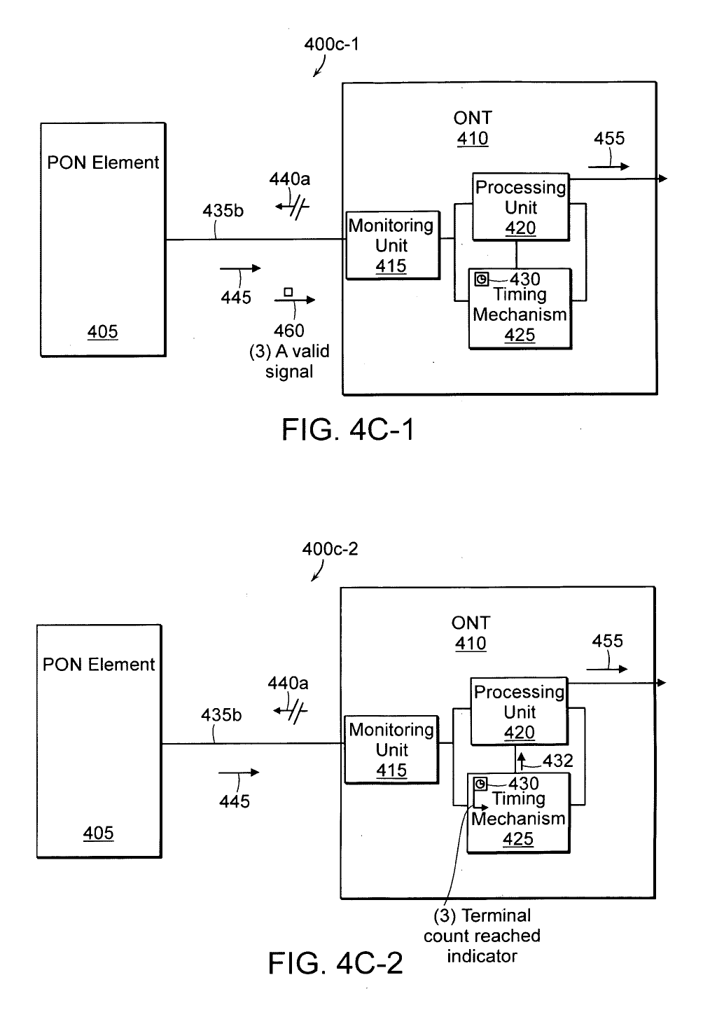

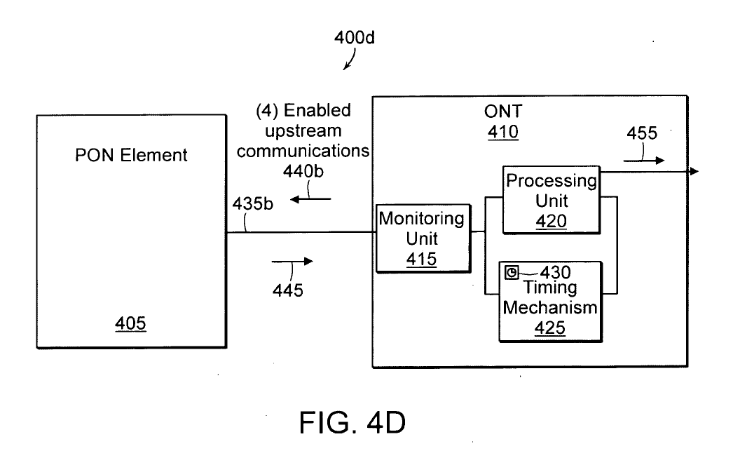

FIGS. 4A-4D are block diagrams of exemplary PONs (400a-d), including a PON element 405 and an ONT 410, according to embodiments of the present invention. In FIG. 4A, the ONT 410 includes a monitoring unit 415, processing unit 420, and timing mechanism 425, which may include an indicator 430. The processing unit 420 connects to customer premises equipment (not shown). The indicator 430 notifies the timing mechanism 425 when the timing mechanism 425 reaches a terminal count. As illustrated in FIG. 4A, there is no communications connection 435a, such as a physical connection, between the PON element 405 and the ONT 410.

As illustrated in FIG. 4B, the ONT 410 may connect to the PON element 405, resulting in a communications connection 435b. The ONT 410 may be set to a disabled state of upstream communications 440a and, therefore, it cannot communicate upstream towards the PON element. The monitoring unit 415 may monitor the communications connection 435b for a downstream signal 445. Once the monitoring unit 415 detects the downstream signal 445, such as a 1490 nanometer wavelength signal, the processing unit 420 may process the downstream signal 445 and transmit a processed downstream signal 455 to customer premises equipment (not shown). Customer premises equipment may include standard telephones (PSTN and cellular), Internet Protocol telephones, Ethernet units, video devices, computer terminals, digital subscriber line connections, cable modems, wireless access, as well as any other conventional device. Therefore, even though the ONT 410 is in a disabled state of upstream communications 440a, it may receive and process downstream signals, such as the aforementioned downstream signal 445.

The disabled state of upstream communications 440a may be an Emergency Stop On (E-STOP-ON) state. When the monitoring unit 415 detects the downstream signal 445, the timing mechanism 425 may start timing a duration of the ONT's being in the disabled state of upstream communications 440a, for example, in response to a start timing mechanism signal 417 from the monitoring unit 415. The downstream signal 445 may include optical signal power. Thereafter, the processing unit 420 may cause the ONT to enter an enabled state of upstream communications 440b (FIG. 4D) in response to an event or receiving optical signal power.

For example, as illustrated in FIG. 4C-1, the PON element 405 may transmit a valid signal 460, such as a PLOAM message, to the ONT 410. If the monitoring unit 415 detects an E-STOP-OFF PLOAM message in the content of the valid signal 460, the processing unit 420 may cause the ONT 410 to enter the enabled state of upstream communications 440b (FIG. 4D). In one embodiment, the processing unit 420 may cause the ONT 410 to enter the enabled state of upstream communications 440b (FIG. 4D) by changing the appropriate ONT configuration settings stored in ONT memory, such as non-volatile memory (not shown). The enabled state of upstream communications 440b (FIG. 4D) may be an Emergency Stop Off (E-STOP-OFF) state. In addition, if the monitoring unit 415 detects an E-STOP-OFF PLOAM message in the valid signal 460, the timing mechanism 425 may abort timing the duration of the ONT's being in the disabled state of upstream communications 440a. On the other hand, if the content of the valid signal 460 includes an E-STOP-ON PLOAM message, the ONT enters a state of disabled upstream communications 440a and aborts timing the duration of the ONT's being in the disabled state of upstream communications 440a.

In another embodiment illustrated in FIG. 4C-2, the timing mechanism 425, which times a duration of the ONT's being in the disabled state of upstream communications 440a, may reach a terminal count. An indicator 430 may notify the timing mechanism 425 that the timing mechanism has reached the terminal count. The timing mechanism 425, in turn, may send a notification signal 432 to the processing unit 420 to cause the ONT 410 to enter the enabled state of upstream communications 440b (FIG. 4D).

FIG. 4D shows the ONT 410 in an enabled state of upstream communications 440b as a result of the processing unit 420 changing the ONT's configuration settings in response to the monitoring unit 415 detecting E-STOP-OFF PLOAM message in the valid signal 460 (FIG. 4C-1) or the indicator 430 notifying the timing mechanism 425 that the timing mechanism has reached the terminal count (FIG. 4C-2).

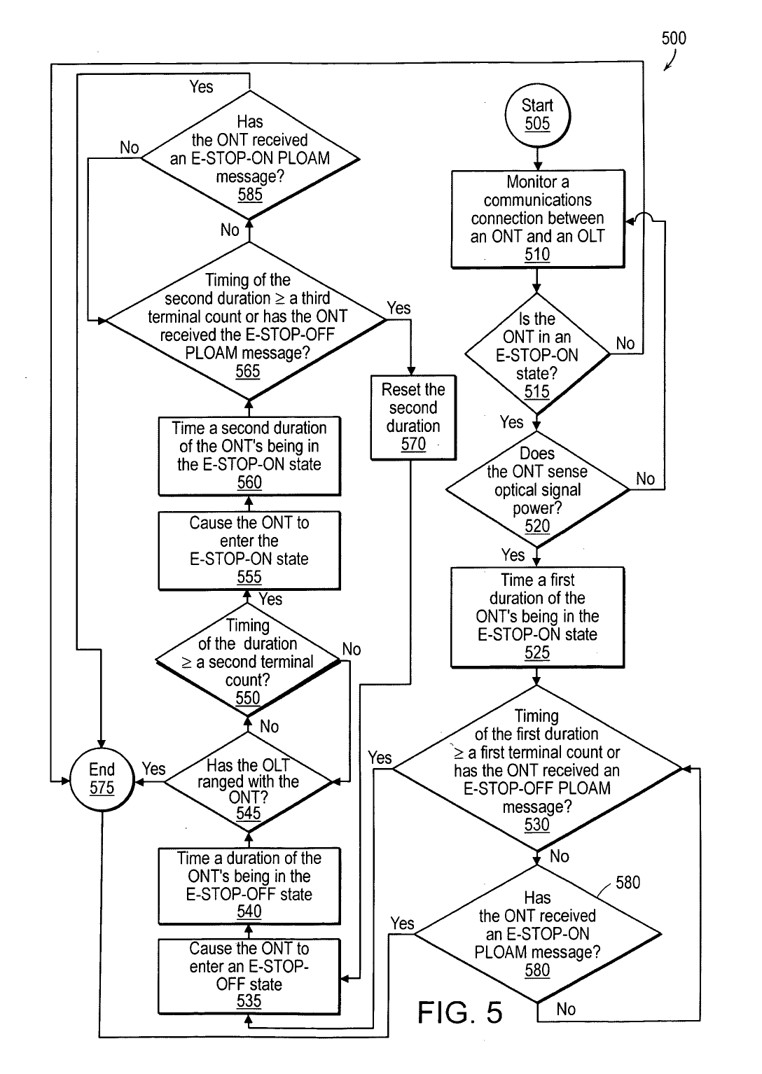

FIG. 5 is an example flow diagram 500 performed in accordance with an embodiment of the present invention. After starting (505), a communications connection between an ONT and an OLT is monitored for a downstream signal (510), such as optical signal power. The ONT may then determine whether it is in an E-STOP-ON state of upstream communications (515). If the ONT determines that it is not in the E-STOP-ON state of upstream communications, (515) the example flow diagram 500 ends (575) and follows a normal method of ranging and activation. The ONT may start again (505) if the ONT is subsequently powered down or loses the downstream optical signal. If the ONT determines that it is in the E-STOP-ON state of upstream communications, the ONT determines whether it senses optical signal power (520). During the E-STOP-ON state, the ONT does not transmit upstream communications signals in an upstream direction, but it may receive and process downstream communications signals sent from the OLT.

If the ONT does not sense optical signal power (520), it continues to monitor for optical signal power (510). If, on the other hand, the ONT senses optical signal power (520), the ONT times a first duration (525) of the ONT's being in the E-STOP-ON state of upstream communications.

Thereafter, the ONT determines whether the timing of the first duration of the ONT's being in the E-STOP-ON state of upstream communications has reached a first terminal count or whether the ONT has received an E-STOP-OFF PLOAM message (530). If the ONT receives an E-STOP-OFF PLOAM message, the ONT enters the E-STOP-OFF state of upstream communications. If the ONT determines that the timing of the first duration did not reach the first terminal count and the ONT did not receive the E-STOP-OFF PLOAM message, the ONT determines whether it has received an E-STOP-ON PLOAM message (580). If the ONT has received an E-STOP-ON PLOAM message, the ONT aborts the timing of the first duration of the ONT's being in the E-STOP-ON state and ends (575). The ONT maintains the E-STOP-ON state of upstream communications. If the ONT determines that it has not received an E-STOP-ON PLOAM message, the ONT continues to determine whether the timing of the first duration has reached a first terminal count or the ONT has received an E-STOP-OFF PLOAM message (530). If the ONT determines that the timing of the first duration of the ONT's being in the E-STOP-ON state has reached the first terminal count or the ONT has received the E-STOP-OFF PLOAM message, the ONT enters the E-STOP-OFF state of upstream communications (535). In addition, the ONT times a duration of the ONT's being in the E-STOP-OFF state of upstream communications (540).

Next, the ONT determines whether or not the OLT has ranged with the ONT (545). If the OLT ranges with the ONT and the ONT maintains the E-STOP-OFF state. If the OLT has not ranged with the ONT, the ONT determines whether the duration of the ONT's being in the E-STOP-OFF state is greater than or equal to a second terminal count (550). If the duration of the ONT's being in the E-STOP-OFF state is not greater than or equal to the second terminal count, the ONT continues to determine whether or not the OLT has ranged with the ONT (545).

There are many reasons why the OLT may not range with the ONT. For example, there may be a fiber break in certain segments of the PON. In another example, the ONT may lose communications with the PON element because there may be a problem in the PON element (e.g., a problem with a PON line card providing a PON element interface on the PON in which the ONT resides) or in the PON line cards (or other line cards that may be required to reboot or may be replaced with another line card.) When the PON line card is replaced with another line card, the communication between the ONT and the PON element is lost and an ONT loss of physical layer-loss of signal (ONT LOPL-LOS) condition occurs. In yet another example, the ONT may lose communications with the OLT because (i) there may be a bad connection between some ODN device splitters and a PON line card, which may cause high bit-error-rates; (ii) the ODN device splitter may simply lose connection with its corresponding ONT; or (iii) a rogue ONT may cause bad communications between all ONTs and the PON line card and thus cause all ONTs' ranging to go down.

If the timing of the duration of the ONT's being in the E-STOP-OFF state is greater than or equal to the second terminal count (550), the ONT enters the E-STOP-ON state (555) and times a second duration of the ONT's being in the E-STOP-ON state (560).

Subsequently, the ONT determines whether (i) the timing of the second duration of the ONT's being in the E-STOP-ON state is greater than or equal to a third terminal count or (ii) the ONT has received an E-STOP-OFF PLOAM message (565). If the ONT determines that the timing of the second duration is not greater than or equal to the third terminal count and the ONT has not received the E-STOP-OFF PLOAM message, the ONT determines whether it has received an E-STOP-ON PLOAM message (585). If the ONT receives an E-STOP-ON PLOAM message, the ONT aborts the timing of the second duration and ends (575). The ONT maintains the E-STOP-ON state of upstream communications. If the ONT has not received an E-STOP-ON PLOAM message, the ONT returns to determine whether (i) the timing of the second duration of the ONT's being in the E-STOP-ON state is greater than or equal to a third terminal count or (ii) the ONT has received the E-STOP-OFF PLOAM message (565). If the ONT determines that the timing of the second duration is greater than or equal to the third terminal count or the ONT receives the E-STOP-OFF PLOAM message, the ONT causes the timing of the second duration of the ONT's being in the E-STOP-ON state to reset (570). If the ONT receives the E-STOP-OFF PLOAM message, the ONT enters an E-STOP-OFF state. The ONT may thereafter repeat: causing the ONT to enter the E-STOP-OFF state (535), timing the duration of the ONT's being in the E-STOP-OFF state (540), causing the ONT to enter the E-STOP-ON state (555), timing the second duration of the ONT's being in the E-STOP-ON state (560), and resetting the timing of the second duration of the ONT's being in the E-STOP-ON state (545) until the OLT ranges with the ONT or the ONT receives an E-STOP-ON PLOAM message (585).

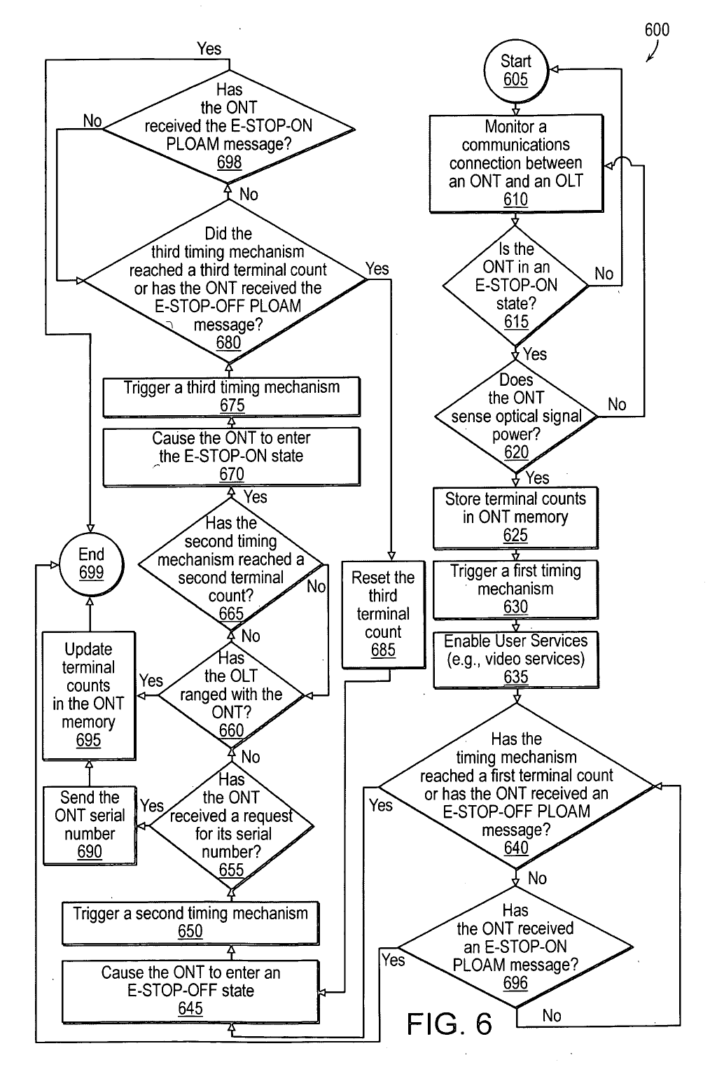

FIG. 6 is an example flow diagram 600 performed in accordance with an embodiment of the present invention. After starting (605), a communications connection between an ONT and an OLT is monitored for optical signal power (610). The ONT then determines whether it is set to E-STOP-ON state (615). If the ONT determines that it is not set to the E-STOP-ON state, it restarts (605) the flow diagram 600. Otherwise, the ONT determines whether it is senses optical signal power (620). If the ONT does not sense optical signal power, it returns to monitor for optical signal power (610). If the ONT senses optical signal power, the ONT may store at least one of a first, second, or third terminal count in ONT memory (625), such as non-volatile flash memory. In addition, the ONT may trigger a first timing mechanism (630) to time a first duration of the ONT's being in the E-STOP-ON state and enable user services (635) in the downstream direction based on default settings stored in the ONT memory.

For example, if the ONT's default settings include a setting to enable user services, the ONT may enable user services even though the ONT is set to the E-STOP-ON state. Conversely, if the ONT's default settings include a setting to disable user services (e.g., when an ONT comes out of manufacturing), the ONT may disable user services even though the ONT is set to the E-STOP-OFF state. The user services may include video services provided on a 1550 nanometer wavelength signal. In the example above, where the ONT's default settings enable video services, a user can connect the ONT to any OLT and receive video services without paying for these services. Thus, the ONT or OLT may be configured to give a service provider the ability to disable video services whether the ONT is set to the E-STOP-ON state or the E-STOP-OFF state.

After user services are enabled, the ONT may determine whether (i) the first timing mechanism, which times the first duration of the ONT's being in the E-STOP-ON state, has reached the first terminal count or (ii) the ONT has received an E-STOP-OFF PLOAM message (640). If the ONT determines that the first timing mechanism has not reached the first terminal count and the ONT has not received the E-STOP-OFF PLOAM message, the ONT determines whether it has received an E-STOP-ON PLOAM message (696). After the ONT receives the E-STOP-ON PLOAM message, the example flow diagram 600 ends (699) the ONT enters and maintains the E-STOP-ON state and ends (699). And the ONT enters and maintains the E-STOP-ON state If the ONT has not received an E-STOP-ON PLOAM message, the ONT returns to determine whether the first timing mechanism has reached the first terminal count or the ONT has received an E-STOP-OFF PLOAM message (640). If the ONT determines that the first timing mechanism has reached the first terminal count or the ONT has received the E-STOP-OFF PLOAM message, the ONT enters the E-STOP-OFF state (645) and triggers a second timing mechanism (650) to time a duration of the ONT's being in the E-STOP-OFF state.

Next, the ONT may determine whether it has received an automatic request (“auto-request”) for its serial number (655) from the OLT. The OLT may automatically send the auto-request to all ONTs' because the OLT may recognize that it does not have a complete list of all ONTs connected to the OLT. For example, an OLT may have an incomplete list of all ONTs connected to it because a technician may install an ONT in the wrong OLT. The auto-request may help a technician find missing ONTs and ensure that proper ONTs are installed in a PON. However, an ONT that is in a disabled state of upstream communications cannot respond to the auto-request. But, embodiments of the present invention cause the ONT to enter the E-STOP-OFF that it may reply to an auto-request. If the ONT receive the auto-request for its serial number, the ONT may determine whether or not the OLT has ranged with the ONT (660).

If the OLT ranges with the ONT while the ONT is in the E-STOP-OFF state, the OLT may update at least one of the stored first, second, or third terminal counts in the ONT's non-volatile flash memory (695). After the update, the flow diagram state 600 ends (699). If the OLT does not range with the ONT, the ONT determines whether or not the second timing mechanism which times the duration of the ONT's being in the E-STOP-OFF state, has reached the second terminal count (665). If the second timing mechanism has not reached the second terminal count, the ONT may return to determine whether or not the OLT has ranged with the ONT (660). If the second timing mechanism reaches the second terminal count, the ONT enters the E-STOP-ON state of upstream communications (670) and triggers a third timing mechanism (675) to time the duration of the ONT's being in the E-STOP-ON state of upstream communications.

Thereafter, the ONT determines whether the third timing mechanism has reached the third terminal count or the ONT has received the E-STOP-OFF PLOAM message (680). If the ONT determines that the third timing mechanism has not reached the third terminal count and the ONT has not received the E-STOP-OFF PLOAM message, the ONT determines whether it has received an E-STOP-ON PLOAM message (698). If the ONT receives the E-STOP-ON PLOAM message, the example flow diagram 600 ends (699) and the ONT enters the E-STOP-ON state. If the ONT has not received the E-STOP-ON PLOAM message, the ONT returns to determine whether the third timing mechanism has reached the third terminal count or the ONT has received the E-STOP-OFF PLOAM message (680). If the ONT determines that the third timing mechanism has reached the third terminal count or the ONT has received the E-STOP-OFF PLOAM message, the third terminal count is reset (685). The ONT may thereafter repeat: causing the ONT to enter the E-STOP-OFF state (645), triggering a second timing mechanism (650) to time a duration of the ONT's being in the E-STOP-OFF state, causing the ONT to enter the E-STOP-ON state (670), triggering a third timing mechanism (675) to time the second duration of the ONT's being in the E-STOP-ON state, and resetting the timing of the second duration of the ONT's being in the E-STOP-ON state (685) until the OLT ranges with the ONT or the ONT receives an E-STOP-ON PLOAM message (698).

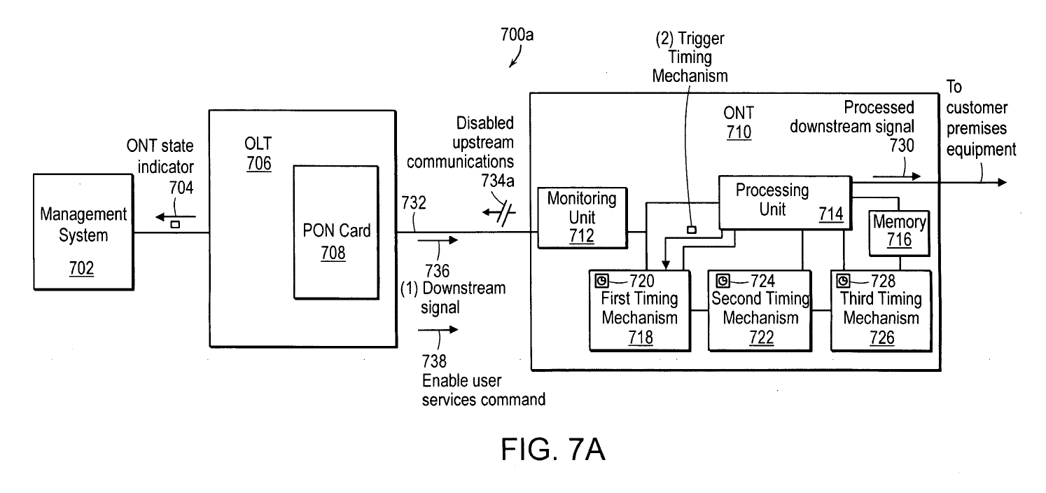

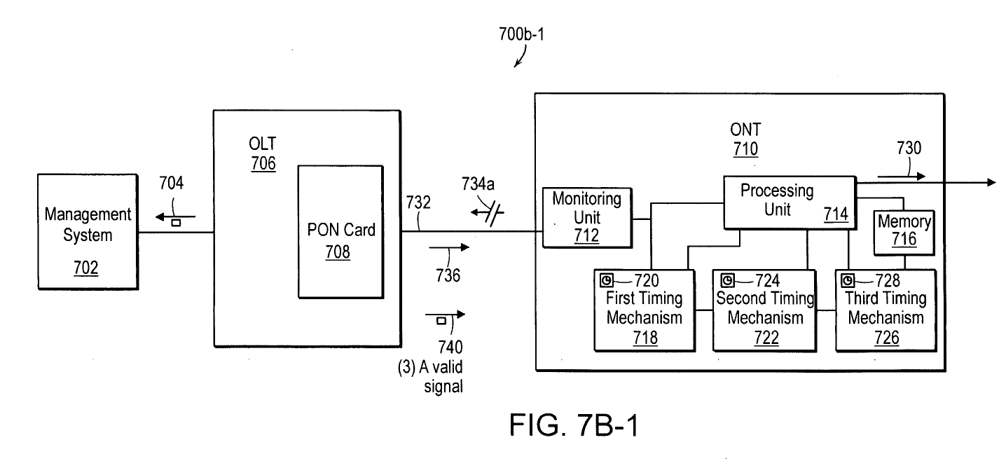

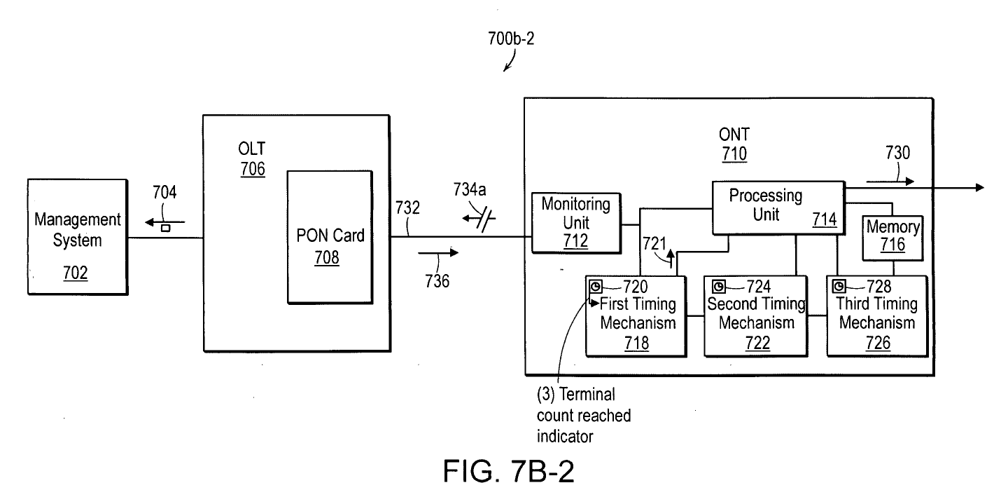

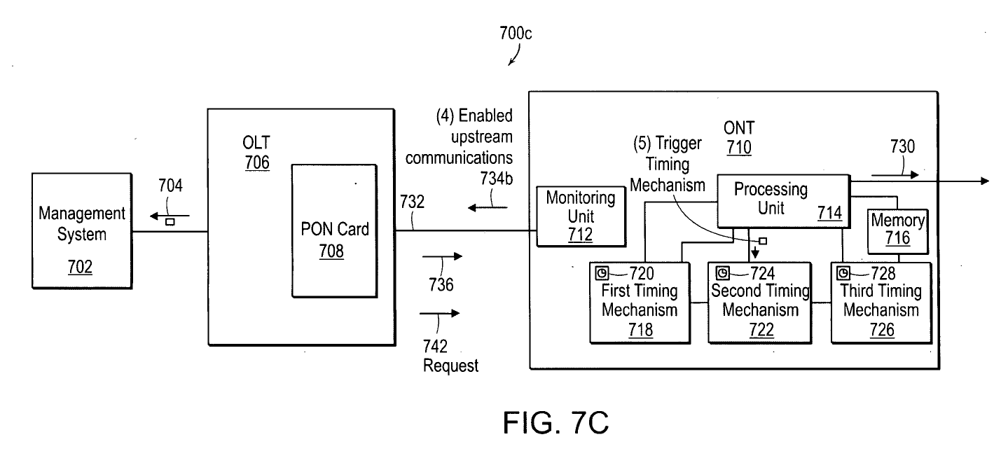

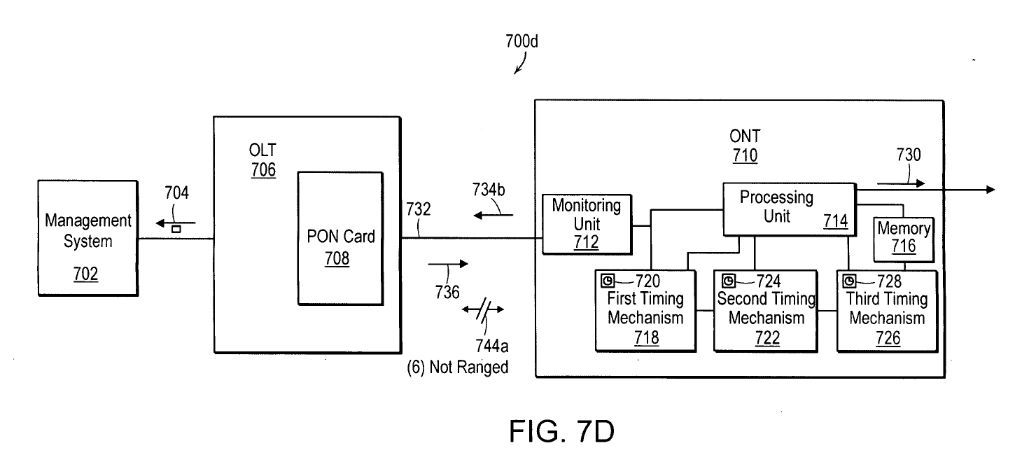

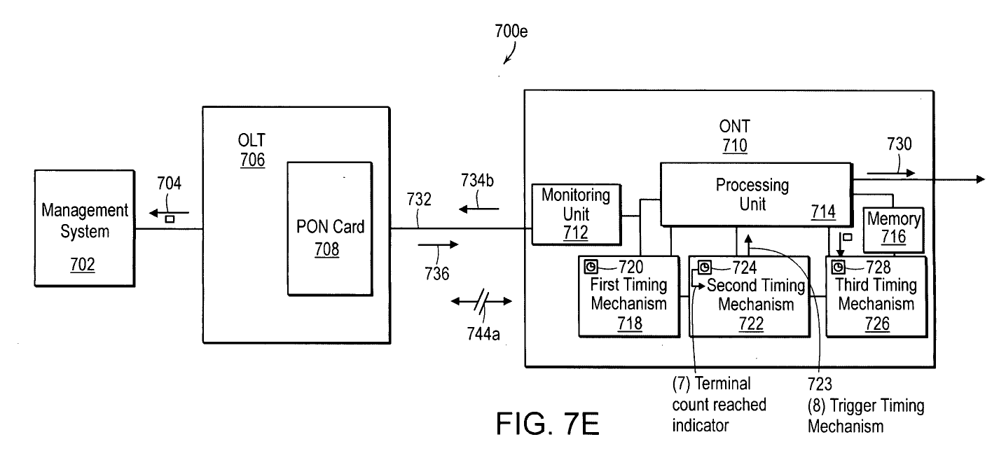

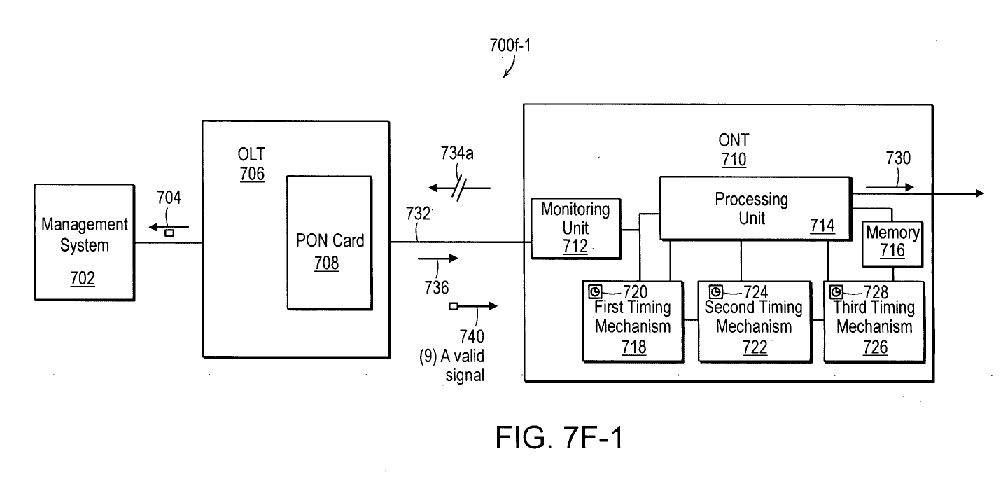

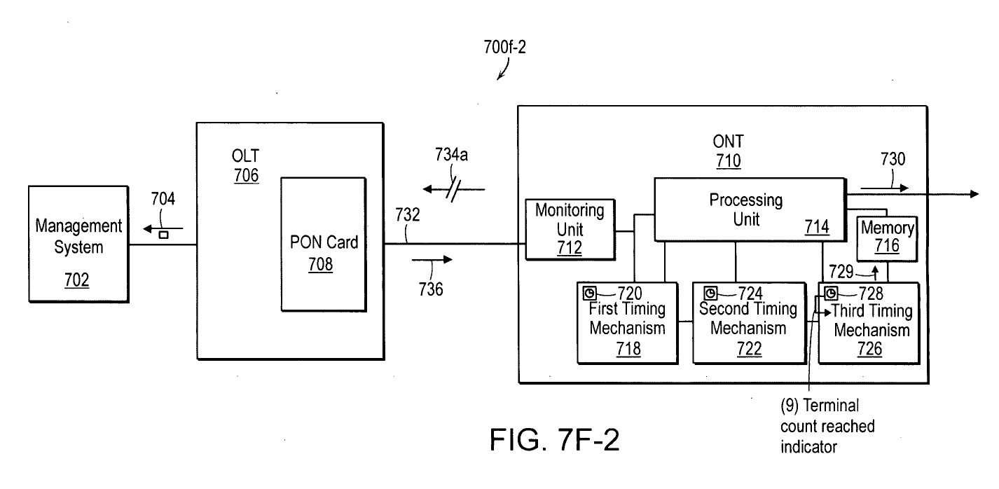

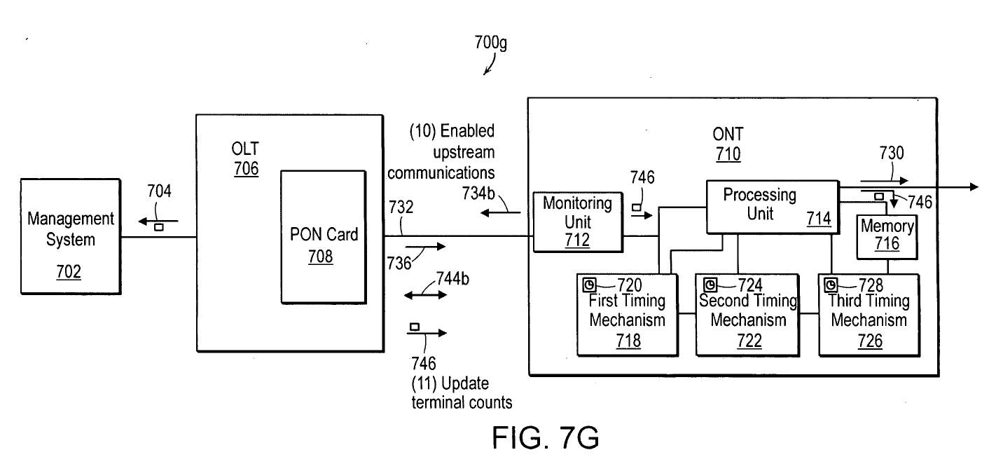

FIGS. 7A-7G are block diagrams of example PONs 700a-700g according to embodiments of the present invention. As illustrated in FIG. 7A, a management system 702 may connect to an OLT 706 which, in turn, may connect to an ONT 710 via a PON card 708. The ONT 710 includes a monitoring unit 712, a processing unit 714, a memory 716, a first timing mechanism 718 having an indicator 720, a second timing mechanism 722 having an indicator 724, and a third timing mechanism 726 having an indicator 728. The memory 716 may include non-volatile flash memory (not shown). The memory 716 may also store a first, second, or third terminal count corresponding to the first, second, or third timing mechanisms 718, 722, 726.

In operation, the OLT 706 may send an ONT state indicator 704 to the management system 702. The ONT state indicator 704 may indicate the status of the ONT 710, such as whether the ONT 710 is in the disabled or enabled state of upstream communications. For example, as illustrated in FIG. 7A, the OLT 706 may detect that ONT 710 is in a state of disabled upstream communications 734a. Accordingly, the OLT 706 may send an ONT state indicator 704 to the management system 702 indicating that ONT 710 is in a state of disabled upstream communications 734a.

The PON Card 708 may send a command 738 to the ONT 710 to cause the ONT 710 to enable or disable user services in the downstream direction based on default settings in the ONT memory 716. For example, if the ONT's 710 default settings include a setting to disable user services (e.g., when an ONT comes out of manufacturing), the processing unit 714 may disable user services even though the ONT 710 is in the enabled state of upstream communications 734b (FIG. 7C). Conversely, if the ONT's 710 default settings include a setting to enable user services, the processing unit 714 may enable user services even though the ONT 710 is in the disabled state of upstream communications 734a. In the latter scenario, a user may connect the ONT 710 to any OLT 706 and receive user services, such as video services, without paying for those services. Thus, a service provider may want the ability to enable and disable video services whether the ONT 710 is in the disabled state 734a or enabled state 734b (FIG. 7C) of upstream communications. Also, under certain conditions, the service provider may want the ONT 710 to default to a disabled user services mode.

In operation, the monitoring unit 712 monitors the communications connection 732 between the ONT 710 and the OLT 706 for a downstream signal 736. After the monitoring unit 712 detects the downstream signal 736, the processing unit 714 may process the downstream signal 736 and transmit a processed downstream signal 730 to customer premises equipment (not shown).

As illustrated in FIG. 7A, the ONT 710 may be in the disabled state of upstream communications 734a, such as the E-STOP-ON state. When the monitoring unit 712 detects the downstream signal 736, the processing unit 714 may trigger the first timing mechanism 718 to time a duration of the ONT's 710 being in the disabled state of upstream communications 734a. Alternatively, the monitoring unit 712 may trigger the first timing mechanism 718 in response to detecting the downstream signal 736. The downstream signal 736 may include optical signal power.

Next, the processing unit 714 may cause the ONT to enter the enabled state of upstream communications 734b (FIG. 7C) in response to an event. For example, in one embodiment illustrated in FIG. 7B-1, the processing unit 714 may cause the ONT 710 to enter the enabled state of upstream communications 734b (FIG. 7C), such as the E-STOP-OFF state, after the ONT 710 detects that the contents of a received valid signal 740 includes an E-STOP-OFF PLOAM message. In addition, the timing mechanism 718 may abort timing the duration of the ONT's 710 being in the E-STOP-ON state of upstream communications 734a.

In another embodiment illustrated in FIG. 7B-2, the first timing mechanism 718, which times a duration of the ONT's 710 being in the disabled state of upstream communications 734a, may reach the first terminal count. An indicator 720 may notify the first timing mechanism 718 that the first timing mechanism 718 has reached the first terminal count. The first timing mechanism 718, in turn, may send a notification signal 721 to the processing unit 714 to cause the ONT 710 to enter the enabled state of upstream communications 734b (FIG. 7C).

As illustrated in FIG. 7C, the processing unit 714 may trigger a second timing mechanism 722 having an indicator 724 to time a duration of the ONT's 710 being in the enabled state of upstream communications 734b. Meanwhile, the OLT 706 may send a request 742 for all serial numbers of ONTs connected to the OLT 706. The ONT 710 may respond to the request by transmitting a message including the ONT's 710 serial number to the OLT 706. Once the OLT 706 knows the ONT's 710 serial number, the OLT 706 may proceed to range with the ONT 710.

As illustrated in FIG. 7D, however, the OLT 706 may fail to range 744a with the ONT 710 while the ONT 710 is in the enabled state of upstream communications 734b.

As illustrated in FIG. 7E, the processing unit 714 may cause the ONT to enter the disabled state of upstream communications 734a (FIG. 7A) in response to the timing duration reaches the second terminal count unless the OLT 706 successfully ranges with the ONT 710 before the timing duration reaches the second terminal count. The indicator 724 notifies the second timing mechanism 722 that the second timing mechanism 722 has reached the second terminal count. The timing mechanism 722, in turn, may send a notification signal 723 to the processing unit 714 to cause a third timing mechanism 726 having the indicator 728 to time a second duration of the ONT's 710 being in the disabled state of upstream communications 734a (FIG. 7A). The processing unit 714, in turn, may cause the ONT's 710 being in the disabled state 734a (FIG. 7A) to enter the enabled state of upstream communications 734b in response to an event.

For example, in one embodiment illustrated in FIG. 7F-1, the processing unit 714 may cause the ONT to enter the enabled state 734b (FIG. 7E) of upstream communications in response to the ONT 710 detecting an E-STOP-OFF PLOAM message in a valid signal 740. The enabled state of upstream communications 734b (FIG. 7E) may be an E-STOP-OFF state. In addition, the third timing mechanism 726 may abort timing the duration of the ONT's being in the disabled state of upstream communications 734a.

In another embodiment illustrated in FIG. 7F-2, the third timing mechanism 726, which times the second duration of the ONT's being in the disabled state of upstream communications 734a, may reach a third terminal count. In response, the indicator 728 may notify the third timing mechanism 726 that the third timing mechanism 726 has reached the third terminal count. The third timing mechanism 726, in turn, may send a notification signal 729 to the processing unit 714 to cause the ONT 710 to enter the enabled state of upstream communications 734b (FIG. 7E). The processing unit 714 may reset the third timing mechanism 726 in the event the second timing mechanism 722 is configured to repeat timing the duration of the ONT's 710 being in the enabled state of upstream communications 734b (FIG. 7E). The processing unit 714 may be configured to repeat causing the ONT 710 to enter the disabled state of upstream communications 734a. The third timing mechanism 726 may be configured to repeat timing the duration of the ONT's 710 being in the disabled state 734a. The processing unit 714 may be configured to repeat causing the ONT 710 to enter the enabled state 734b (FIG. 7E) until the OLT 706 ranges with the ONT 710.

FIG. 7G shows the ONT 710 in the enabled state of upstream communications 734b after the ONT 710 detects an E-STOP-OFF PLOAM message in the valid signal 740 (FIG. 7B-1) or the third timing mechanism, which times the duration of the ONT's being in the disabled state of upstream communications 734a (FIG. 7A), reaches the third terminal count. The ONT 710 may successfully range 744b with the OLT 706 and, such as update the first, second, and third terminal counts 746 in ONT memory 716 non-volatile flash memory (not shown).

While this invention has been particularly shown and described with references to example embodiments thereof, it will be understood by those skilled in the art that various changes in form and details may be made therein without departing from the scope of the invention encompassed by the appended claims.

It should be understood that the terminal counts may define any lengths of time (e.g., 5 seconds, 30 minutes, or 8 hours) during which the ONT maintains itself in an enable or disabled state of upstream communications. The terminal counts may be set, for example, in accordance with the requirements of the service provider or to account for the various situations that may arise.

The timing mechanisms may be implemented as count-up timers, count-down timers, or any form of timing mechanisms that can be used to time a duration of the ONT's being in the disabled or enabled state of upstream communications. Also, the timing mechanisms may be implemented as a single timer or combination of multiple timers. The single timer may include an indicator that indicates when the timer has reached any number of terminal counts. Various embodiments may include any number of timing mechanisms and any number of associated terminal counts.

In other embodiments, if at anytime the ONT receives an E-STOP-ON PLOAM message, the ONT enters and maintains the disabled state of upstream communications and aborts or exits embodiments of the example flow diagrams illustrated in FIGS. 3, 5, and 6 (see, e.g., FIG. 6, reference numbers 696, 698, and 699).

It should be understood that any of the above-described flow diagrams of FIGS. 3, 5, and 6 or underlying methods used to implement aspects related to the networks of FIGS. 4A-4D and 7A-7G may be implemented in the form of hardware, firmware, or software. If implemented in software, the software may be in any suitable form of software that can be stored on any form of machine-readable medium (e.g., CD-ROM), and loaded and executed by at least one general purpose or application specific processor.

What is claimed is:

1. A method of enabling an Optical Network Terminal (ONT) in a Passive Optical Network (PON), the method comprising:
monitoring a communications connection between an ONT and a PON element for a downstream signal;
timing a duration of the ONT's being in a disabled state of upstream communications after detecting the downstream signal; and
causing the ONT (i) to enter an enabled state of upstream communications in response to the timing of the duration reaching a terminal count or ONT (ii) to enter a state of upstream communications based on content of a received valid signal.

2. The method according to claim 1 wherein the content of the received valid signal includes an Emergency Stop On (E-STOP-ON) Physical Layer Operation, Administration, and Management (PLOAM) message that causes the ONT to enter the disabled state of upstream communications.

3. The method according to claim 1 wherein the content of the received valid signal includes an Emergency Stop Off (E-STOP-OFF) Physical Layer Operation, Administration, and Management (PLOAM) message that causes the ONT to enter the enabled state of upstream communications.

4. The method according to claim 1 wherein the disabled state of upstream communications is an Emergency Stop On (E-STOP-ON) state and the enabled state of upstream communications is an Emergency Stop Off (E-STOP-OFF) state.

5. The method according to claim 1 wherein the PON element is a management system, PON card, or Optical Line Terminal (OLT).

6. The method according to claim 1 wherein monitoring the communications connection between the ONT and the PON element includes sensing optical signal power.

7. The method according to claim 1 further including responding to a request from the PON element for the ONT serial number during the enabled state.

8. The method according to claim 1 further including enabling or disabling user services in a downstream direction during the disabled state based on a default setting in the ONT.

9. The method according to claim 8 wherein the user services include video services.

10. The method according to claim 1 wherein the terminal count is a first terminal count and the method further including:
timing a duration of the ONT's being in the enabled state; and
causing the ONT to enter the disabled state in response to the timing of the duration reaching a second terminal count unless the PON element successfully ranges with the ONT before reaching the second terminal count.

11. The method according to claim 10 wherein the duration of the ONT's being in the disabled state is a first duration and the method further including:
timing a second duration of the ONT's being in the disabled state; and
causing the ONT (i) to enter the enabled state in response to the timing of the second duration reaching a third terminal count or in response to receiving an E-STOP-OFF PLOAM message from the PON element, or (ii) to enter the disabled state of upstream communications in response to receiving an E-STOP-ON PLOAM message from the PON element.

12. The method according to claim 10 further including resetting the timing of the second duration.

13. The method according to claim 11 further including repeating: timing the duration of the ONT's being in the enabled state, causing the ONT to enter the disabled state, timing the second duration of the ONT's being in the disabled state, causing the ONT to enter the enabled state, and resetting the timing of the second duration.

14. The method according to claim 10 wherein timing the durations include triggering at least one timing mechanism.

15. The method according to claim 10 further including storing at least one of the first, second, or third terminal counts.

16. The method according to claim 14 further including updating by the PON element at least one of the stored first, second, or third terminal counts.

17. An Optical Network Terminal (ONT) in a Passive Optical Network (PON) comprising:
a monitoring unit configured to monitor a communications connection between an ONT and a PON element for a downstream signal;
a timing mechanism including an indicator, the timing mechanism configured to time a duration of the ONT's being in a disabled state of upstream communications in response to the monitoring unit's detecting the downstream signal; and
a processing unit configured to cause the ONT (i) to enter an enabled state of upstream communications in response to the timing mechanism's indicator notifying the timing mechanism that it has reached a terminal count or (ii) to enter a state of upstream communications based on content of a received valid signal.

18. The ONT according to claim 17 wherein the content of the received valid signal includes an Emergency Stop On (E-STOP-ON) Physical Layer Operation, Administration, and Management (PLOAM) message that causes the ONT to enter the disabled state of upstream communications.

19. The ONT according to claim 17 wherein the content of the received valid signal includes an Emergency Stop Off (E-STOP-OFF) Physical Layer Operation, Administration, and Management (PLOAM) message that causes the ONT to enter the enabled state of upstream communications.

20. The ONT according to claim 17 wherein the disabled state of upstream communications is an Emergency Stop On (E-Stop-ON) state and the enabled state of upstream communications is an Emergency Stop Off (E-Stop-OFF) state.

21. The ONT according to claim 17 wherein the PON element is a management system, PON card, or Optical Line Terminal (OLT).

22. The ONT according to claim 17 wherein the downstream signal includes optical signal power.

23. The ONT according to claim 17 wherein the processing unit is further configured to respond to a request from the PON element for the ONT serial number during the enabled state.

24. The ONT according to claim 17 wherein the processing unit enables or disables user services in a downstream direction during the disabled state based on a default setting in the ONT.

25. The ONT according to claim 24 wherein the user services include video services.

26. The ONT according to claim 17 wherein the timing mechanism is a first timing mechanism and the terminal count is a first terminal count and the ONT further including:
a second timing mechanism including an indicator, the second timing mechanism configured to time a duration of the ONT's being in the enabled state, the processing unit further configured to cause the ONT to enter the disabled state in response to the second timing mechanism's indicator notifying the second timing mechanism that it has reached a second terminal count, unless the PON element successfully ranges with the ONT before reaching the second terminal count.

27. The ONT according to claim 26 wherein the duration of the ONT's being in the disabled state is a first duration and the ONT further includes:
a third timing mechanism including an indicator, the third timing mechanism configured to time a second duration of the ONT's being in the disabled state, the processing unit further configured to cause the ONT (i) to enter the enabled state in response to the third timing mechanism's indicator notifying the third timing mechanism that it has reached a third terminal count or in response to receiving an E-STOP-OFF PLOAM message from the PON element, or (ii) to enter the disabled state of upstream communications in response to receiving an E-STOP-ON PLOAM message from the PON element.

28. The ONT according to claim 27 wherein the processing unit is configured to reset the third timing mechanism.

29. The ONT according to claim 28 wherein (i) the second timing mechanism is configured to repeat timing the duration of the ONT's being in the enabled state,
(ii) the processing unit is configured to repeat causing the ONT to enter the disabled state, (iii) the third timing mechanism is configured to repeat timing the duration of the ONT's being in the disabled state, (iv) the processing unit is configured to repeat causing the ONT to enter the enabled state, and (v) the processing unit is configured to repeat resetting the third timing mechanism, until the PON element ranges with the ONT.

30. The ONT according to claim 27 wherein the first, second, and third timing mechanisms are a single timing mechanism.

31. The ONT according to claim 27 further including a memory coupled to at least one of the timing mechanisms and configured to store at least one of the first, second, or third terminal counts.

32. The ONT according to claim 31 wherein the PON element is configured to update at least one of the first, second, or third terminal counts in the memory.

33. A computer program product for configuring an Optical Network Terminal (ONT) in a Passive Optical Network (PON), the computer program product comprising a computer readable medium having computer readable instructions stored thereon, which, when loaded and executed by a processor, causes the processor to:
monitor a communications connection between an ONT and a PON element for a downstream signal;
time a duration of the ONT's being in a disabled state of upstream communications after detecting the downstream signal; and
cause the ONT (i) to enter an enabled state of upstream communications in response to the timing of the duration reaching a terminal count or (ii) to enter a state of upstream communications based on content of a received valid signal.
